(19) United States
(12) Patent Application Publication
(10) Pub. No.: US 2006/0284397 A1
(43) Pub. Date: Dec. 21, 2006

(54) Trailers

(75) Inventor: Nicholas Lambert, Botany, New South Wales (AU)

Correspondence Address: ABELMAN, FRAYNE & SCHWAB, 666 THIRD AVENUE, 10TH FLOOR, NEW YORK, NY, 10017, US

(73) Assignee: TUCK-A-WAY ENGINEERING & DESIGN PTY LIMITED, Botany, New South Wales (AU)

(21) Appl. No.: 10/553,220

(22) PCT Filed: Oct. 6, 2004
(86) PCT No.: PCT/AU04/01354

§ 371 Date: Oct. 14, 2005

(51) Int. Cl. B60D 1/54

(52) U.S. Cl. 280/491.1

(57) ABSTRACT

A trailer having a frame, a hitch apparatus (6) including a tow head adaptor securable to the tow bar of a towing vehicle, universal joint means extending between and linking the tow head adaptor and a tow head bracket attached to the trailer frame in a manner permitting an extended range of towing angles and the tow head bracket being pivotal on the trailer frame between a forwardly extending operative position for the hitch apparatus and an inoperative space saving storage position.

In another embodiment the trailer is collapsible, including a removable cargo tray. In a further embodiment the trailer includes a wheel trough (1) for carrying a motorcycle.

### FIELD OF THE INVENTION

This invention relates to vehicles. More particularly, although not exclusively it discloses improvements in collapsible trailers.

### BACKGROUND TO THE INVENTION

While collapsible trailers, such as that described in Australian patent appln. 2002301958, are known in the prior art these vehicles have a number of disadvantages. For example the conventional tow ball hitches which are normally used with existing trailers have a limited range of towing angles. During off road use when extreme loads and towing conditions may be encountered these types of hitches can break or detach. Also, with known collapsible trailers the frames are mounted directly to the wheel axles so that the only isolation from rough road surfaces comes from the pneumatic tyres. Further, existing collapsible trailers are typically constructed for a single purpose such as carriage of motorcycles and they cannot be readily adapted for general use with other types of loads.

### SUMMARY OF THE INVENTION

It is therefore an object of this invention to ameliorate the aforementioned disadvantages and according a trailer is disclosed having a hitch apparatus which includes a tow head adapter securable to the tow bar of a towing vehicle, universal joint means extending between and linking said tow head adapter and a tow head bracket attached to said trailer frame in a manner permitting an extended range of

towing angles and said tow bracket being pivotal on said trailer frame between a forwardly extending operative position for said hitch apparatus and an inoperative space saving storage position.

Preferably the trailer is collapsible and also includes suspension blocks attached to the trailer frame which are carried in respective pairs of compression coil springs acting between said blocks and wheel mounting plates.

It is further preferred that said trailer include a detachable cargo tray for general utility use.

### BRIEF DESCRIPTION OF THE DRAWINGS

The currently preferred example of the invention will now be described with reference to the attached drawing in which:

FIG. 1 is a schematic perspective view of a first embodiment of a trailer according to this invention,

FIG. 2 is a schematic plan view of the trailer of FIG. 1,

FIGS. 3 to 7 are schematic plan and side elevation views of the trailer of FIG. 1 in progressive stages of collapse to the storage configuration,

FIG. 8 is a schematic detailed view of the preferred form of hitch apparatus for the trailer of FIG. 1,

FIG. 9 is a cross-sectional view along the lines A-A of FIG. 1 showing the preferred form of suspension for the trailer, and

FIG. 10 is a schematic underside view of a second embodiment of a trailer according to this invention.

### DETAILED DESCRIPTION OF THE PREFERRED EMBODIMENTS

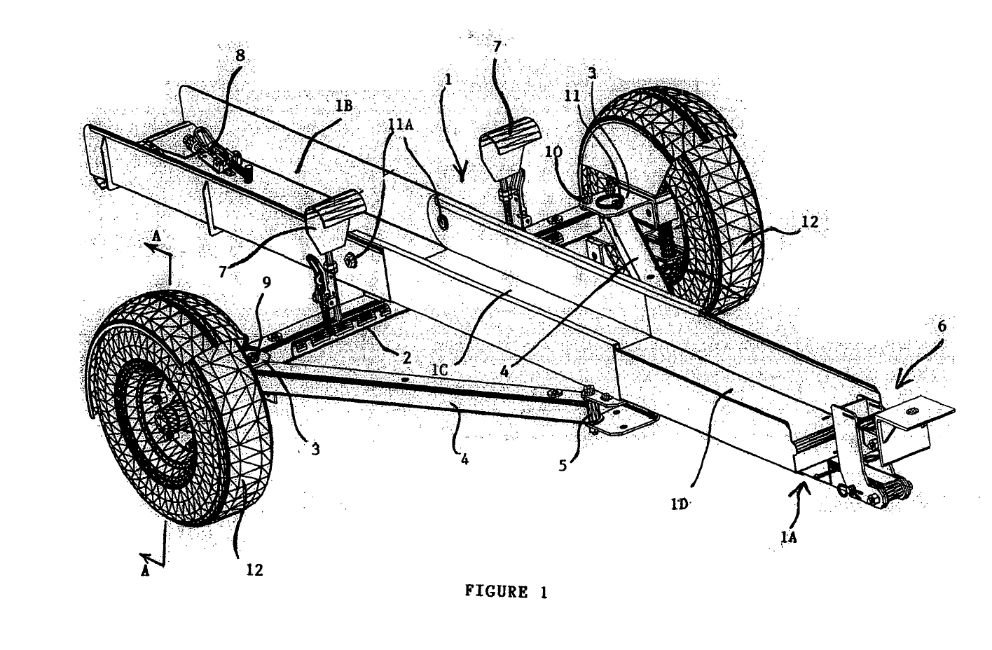

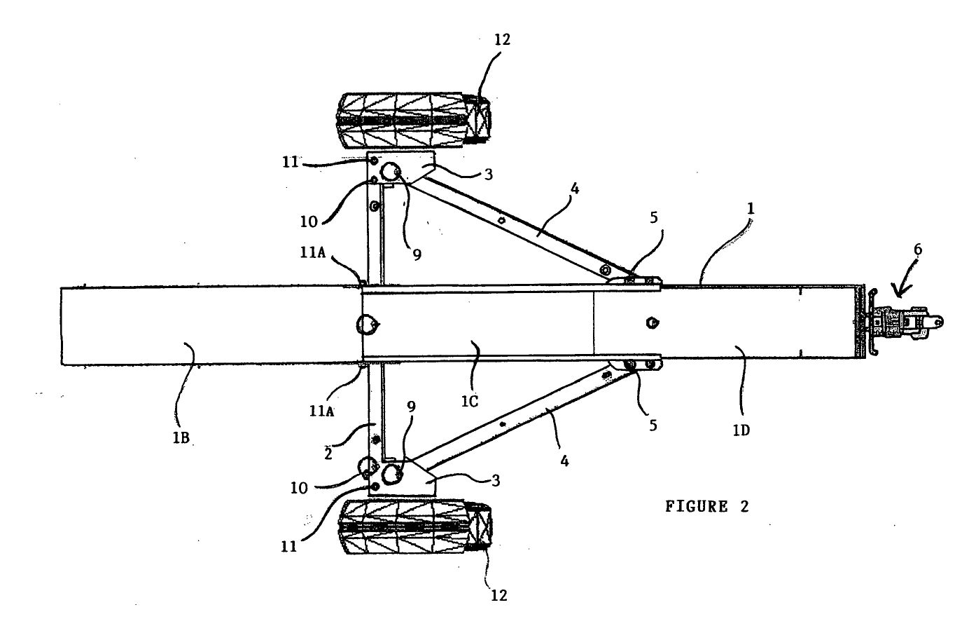

Referring first to FIGS. 1 and 2 the collapsible trailer shown comprises a trough indicated generally as 1 which sits on a centre support rail 1A, a transverse cross-member 2 connecting between wheel and stud axle assemblies 3 at each side and respective side links 4 extending forwardly and inwardly from each of said assemblies 3 to pivot fittings 5 on the rail 1A. The forward end of the rail 1A terminates at a hitch apparatus 6 which will be described in more detail later. There are also foot peg clamps 7 fitted to the cross-member 2 for securing a motorcycle (not shown) at the upright position in the trough 1. When not in use these pegs may be stored adjacent the back end 8 of said trough.

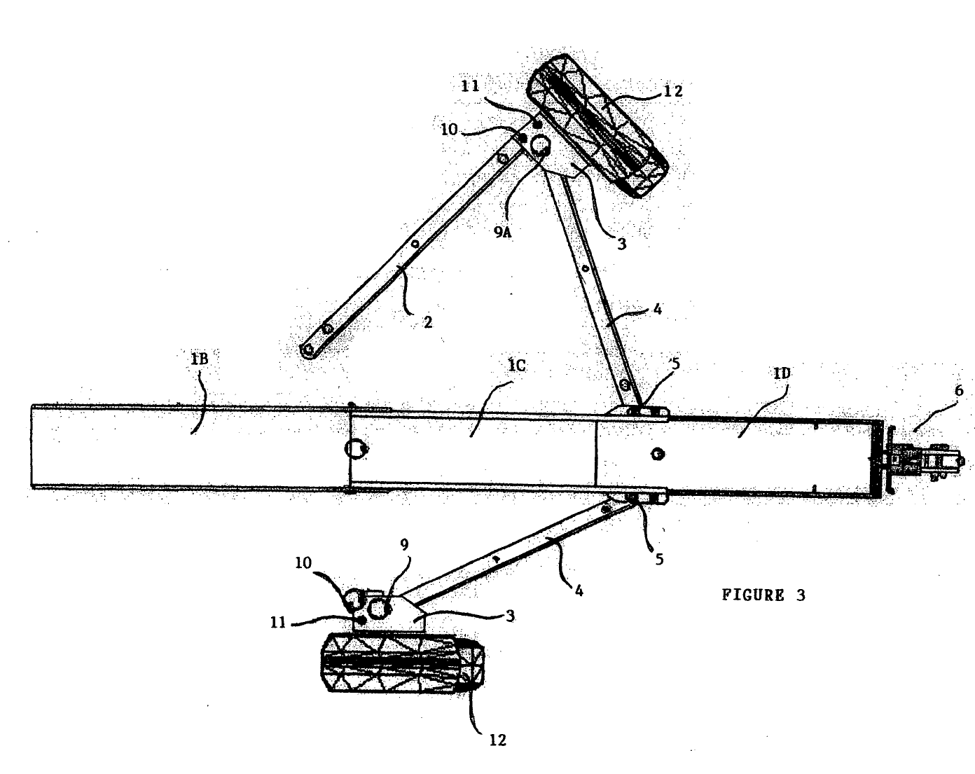

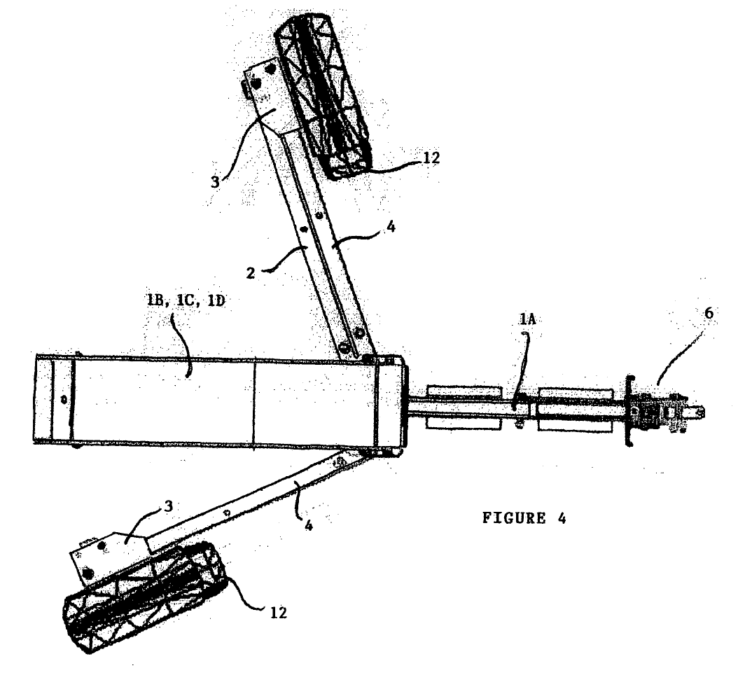

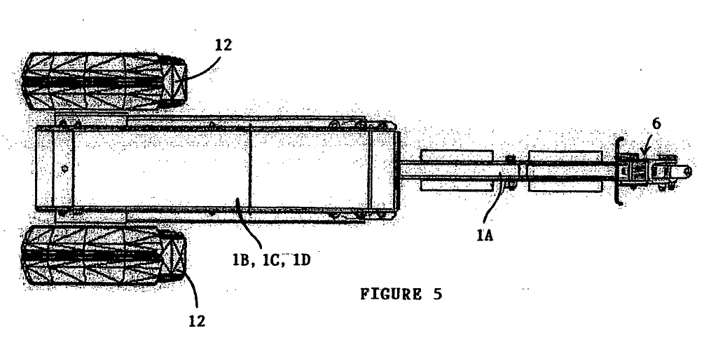

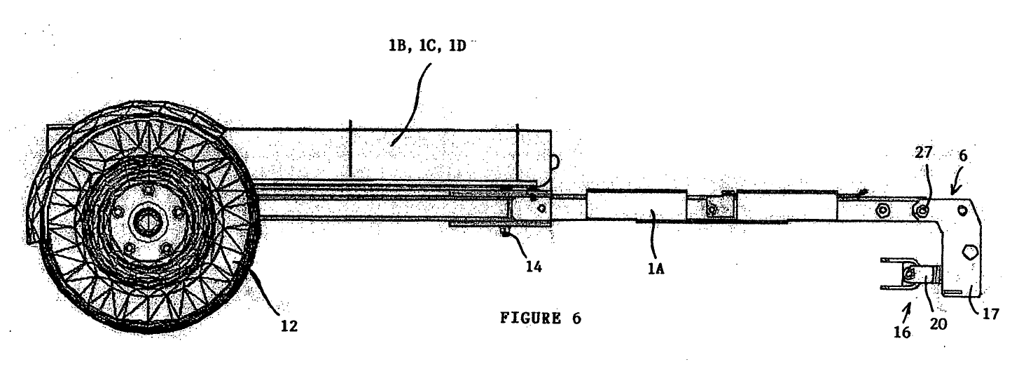

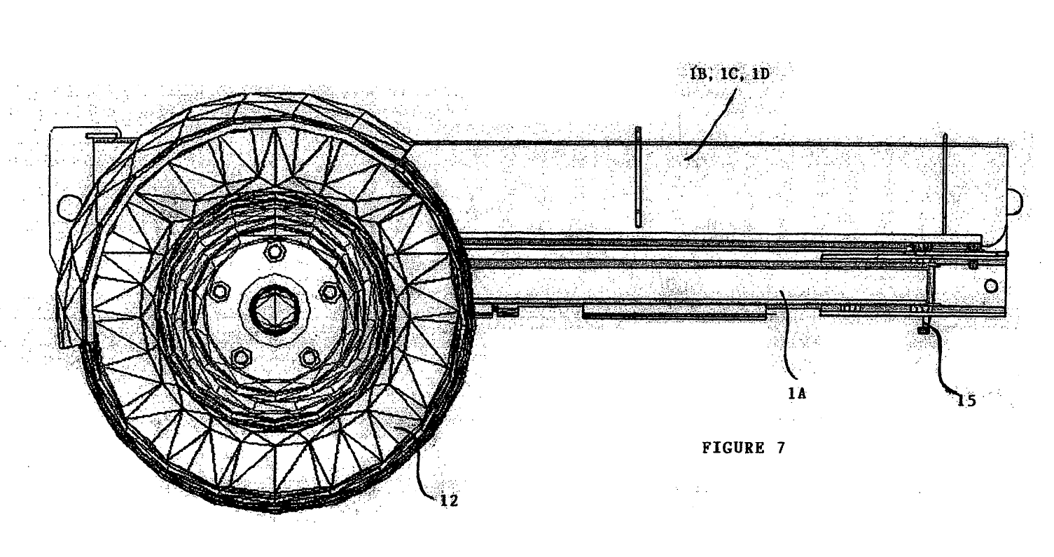

The cross-member 2, side links 4 and support rail 1A are attached together by any suitable form of pin and hinge connections 5, 9, 10, and 11 adjacent their ends. These allow either a pivoting movement of the attached members and/or disconnection. The trough is also preferably formed in three sections 1B, 1C and 1D. The rear section 1B is hinged at 11A to the fixed centre section 1C and can be folded forward onto it. The front section 1D is adapted to telescope rearwards into said centre section. As best shown in FIGS. 3 to 7 by removing the appropriate pins cross-member 2 is detached from the right stub axle assembly 3 so that both stud axle assemblies can then be pivoted inwardly on side links 4 to lie close up against the trough. Finally the support rail 1A is turned back around a pivot 14 as shown in FIG. 6 and 7 to lie parallel to the side links 4 and folded trough sections. This provides compact space saving configuration for the trailer when not in use.

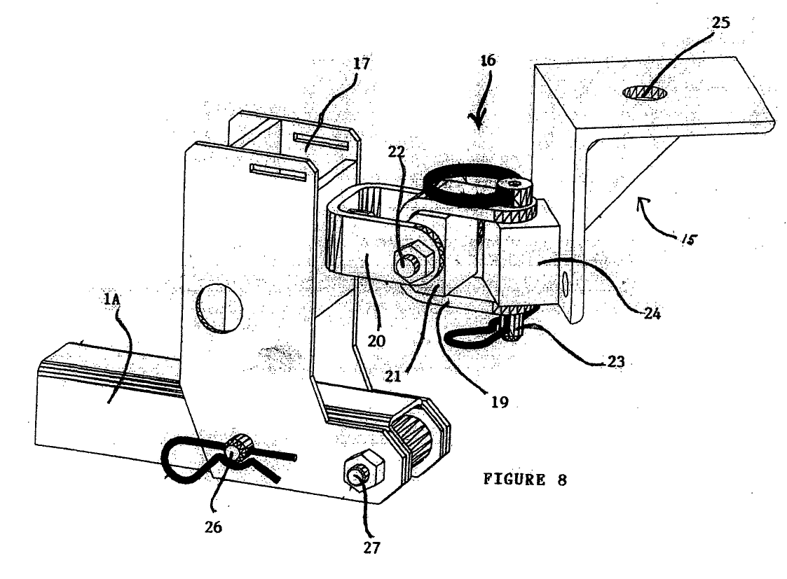

In accordance with this invention and as best shown in FIG. 8 the hitch apparatus 6 for the trailer preferably includes a right angled tow bar adapter 15 and universal joint 16 which links said adapter to a tow head bracket 17 mounted to the end of the support rail 1A. The universal joint preferably comprises a pair of aligned U flanges 19, 20 which are orientated at 900 with respect to each other. They are coupled together by means of a web 21 welded into the closed end of the forward flange 19 which receives a transverse pivot bolt 22 also passing through the open ends of the rear U flange 20. The ends of the forward U flange 19 are also attached by a removable spring clip and pivot pin 23 to a block 24 on the rear face of the tow bar adapter 15. At the opposite end of the universal joint the closed end of the rear flange 20 is mounted to the forward face of the tow head bracket 17 by a bolt or pin (not shown) which is orientated parallel to the length of the support rail 1A. The horizontal plate of the tow bar adapter 15 is formed with an aperture 25 of sufficient size to receive a standard tow ball bolt (not shown).

In use of the trailer the hitch assembly can be attached under the tow ball of a conventional vehicle tow bar. This is done by removing the tow ball bolt, fitting the connector aperture 25 onto the bolt and then refitting and tightening the tow ball onto the tow bar. This provides a rigid load bearing connection which is substantially stronger than conventional ball and socket arrangements. The aforementioned pin and bolt connections throughout the universal joint also permit greater towing angles of up to ±90° horizontal and ±90° vertical between the trailer and tow vehicle. Subsequent disconnection of the hitch is obtained by simply removing the spring clip and pivot pin 23.

When the trailer is not in use and is collapsed into the aforementioned storage configuration the entire hitch apparatus can be turned to an inoperative space saving storage configuration by removing the spring clip and locking pin 26 and then pivoting the hitch downward about bolt 27 as shown in FIG. 6.

A further novel feature of the invention as best shown in

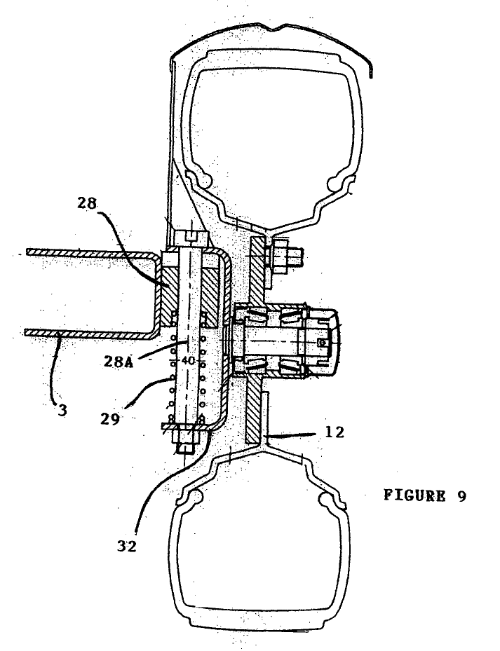

FIG. 9 comprises suspension blocks 28 fitted to the stub axle assemblies 3 on each side of the trailer. These blocks slide on pins 28A and are resiliently supported on respective compression coil springs 29 acting between said blocks and wheel axle mounting plates 30.

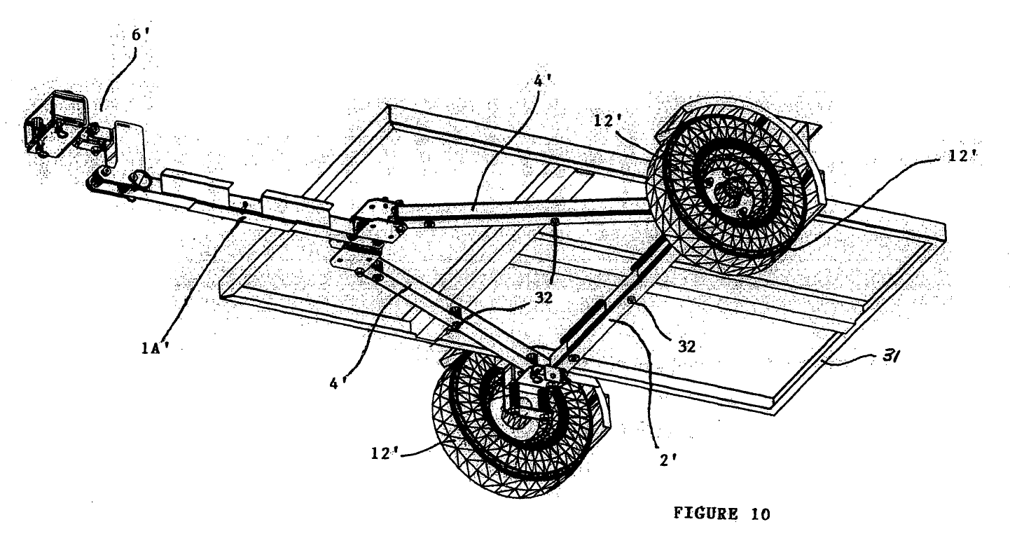

With the second embodiment of the invention shown in FIG. 10 the main components that correspond in function to those of FIGS. 1 to 9 are identified by the same numbers which however are primed (′) to distinguish them.

In this case the motorcycle trough of the first embodiment is omitted and a box shaped cargo tray 31 is mounted to the cross-member 2′ and side links 4′ by bolts 32. This tray forms a platform which enables the trailer to be adapted for carrying a variety of general cargo. When not required the tray is easily removed and stored in an upright position against a garage wall or the like. Although not shown in the drawings the tray may have fittings to enable it to be hung or attached to said wall.

It will thus be appreciated that this invention at least in the form of the examples disclosed provides novel and useful improvements to collapsible trailers. Clearly however the examples described are only the currently preferred forms of the invention and a wide variety of modification may be made which would be apparent to a person skilled in the art. For example the shape and configuration of the trailer frame and removable cargo tray may be changed according to design preference or to adapt the trailer to various tow vehicles and types of cargo.

1. A trailer having a hitch apparatus which includes a tow head adapter securable to the tow bar of a towing vehicle, universal joint means extending between and linking said tow head adapter and a tow head bracket attached to said trailer frame in a manner permitting an extended range of towing angles and said tow head bracket being pivotal on said trailer frame between a forwardly extending operative position for said hitch apparatus and an inoperative space saving storage position.

2. The trailer as claimed in claim 1 wherein the universal joint means includes a pair of aligned U flanges which are orientated at 900 with respect to each other.

3. The trailer as claimed in claim 2 wherein the U flanges are coupled together by a web located within the closed end of one of said U flanges and receiving a bolt or pin which passes through the open ends of the other of said U flanges.

4. The trailer as claimed in claim 3 wherein said one of the U flanges is connected to the tow head adapter by a removable bolt or pin which extends through the open ends of said one of the U flanges and a block on the rear face of said tow bar adapter.

5. The trailer as claimed in claim 4 wherein the closed end of the other of said U flanges is mounted to the tow head bracket by a bolt or pin which is orientated parallel to the length of the trailer frame.

6. The trailer as claimed in claim 1 wherein the tow head adapter has a plate formed with an aperture of sufficient size to receive a standard tow ball bolt whereby said plate can be rigidly bolted onto the tow bar using said tow ball bolt.

7. The trailer as claimed in claim 1 wherein said trailer is collapsible from an operative configuration of use to an inoperative space saving configuration and said trailer includes suspension blocks fitted to stub axle assemblies on each side thereof, said blocks being slidable on pins and being resiliently supported on respective compression springs acting between said blocks and wheel axle mounting plates.

8. The trailer as claimed in claim 1 and further including a removable cargo tray which in use forms a platform for carrying a variety of general cargo on said trailer.

9. The trailer as claimed in claim 1 wherein said trailer includes a wheel trough for carrying a motorcycle and foot peg clamps which are attachable to the trailer frame on each side of the wheel trough for securing said motorcycle at the upright position in said trough.

10. A hitch apparatus for a trailer, said apparatus including a tow head adapter rigidly securable to a tow bar of a towing vehicle, a universal joint extending between and linking said tow head adapter and a tow head bracket for attachment to the trailer frame in a manner permitting an extended range of towing angles.
